(19) United States
(12) Patent Application Publication
(10) Pub. No.: US 2010/0180206 A1
(43) Pub. Date: Jul. 15, 2010

(54) SYSTEMS AND METHODS FOR ICONIC GRAPHICAL USER INTERFACE AND EMBEDDED DEVICE MANAGER

(75) Inventors: Carl L. Silva, JR., El Cajon, CA (US); Dhonn V. Lushine, San Diego, CA (US); Adam J. Porter, Ramona, CA (US); Guillermo Will Amador, Imperial Beach, CA (US)

Correspondence Address: PAUL, HASTINGS, JANOFSKY & WALKER LLP, 875 15th Street, NW, Washington, DC, 20005, US

(73) Assignee: NexAira, Inc., San Diego, CA (US)

(21) Appl. No.: 12/410,401

(22) Filed: Mar. 24, 2009

Related U.S. Application Data
(60) Provisional application No. 61/145,512, filed on Jan. 16, 2009.
(60) Provisional application No. 61/145,112, filed on Jan. 15, 2009.

(51) Int. Cl. G06F 3/048; G06F 15/16

(52) U.S. Cl. 715/744; 709/203

(57) ABSTRACT

Systems and methods are provided that easily interface with, configure, and manage embedded devices, such as telecommunication devices, and that interface with, configure, and manage networks equipped with such embedded devices. In some embodiments, a system comprising a graphical user interface with common abstractions for the settings of an embedded device is presented to a user. In some embodiments, the abstractions are displayed to the user as intuitive icons. In some embodiments, these icons use pictures, colors, and/or other graphical and animation techniques to illustrate device management functions to a user. Using embodiments, the user is able to easily determine how he/she wants the embedded device configured, and can also quickly configure the device in that manner without having to be familiar with the underlying settings of the device. Further, the user can use the interface to manage the device by changing settings or uses of the device as necessary. In some embodiments, the system and its graphical user interface acts as a “skin” over an existing legacy user interface of the embedded device, permitting the system to be easily implemented on top of essentially any embedded device with a web server. Furthermore, the system can be used to implement and manage networks of embedded devices using the same methods disclosed herein.

### CROSS-REFERENCE TO RELATED APPLICATIONS

This application claims priority to U.S. Provisional Patent Application Ser. No. 61/145,512, filed Jan. 16, 2009 and entitled “Systems and Methods for Iconic Router Graphical User Interface,” and U.S. Provisional Patent Application Ser. No. 61/145,112, filed Jan. 15, 2009 and entitled “Systems and Methods for Iconic Router Graphical User Interface,” both of which applications are incorporated herein by reference in their entirety.

### BACKGROUND

1. Field

This invention generally relates to systems and methods for interfacing with an electronic device, and more specifically to systems and methods for providing a graphical user interface to interface with, configure, and manage an embedded device, such as a router, and to interface with, configure, and manage networks equipped with such embedded devices.

2. Description of Related Art

As electronic devices such as personal computers and cellular phones have become more advanced and less expensive, consumers have increased their use of and reliance on such devices. Today, such electronic devices are a necessity in the daily lives of millions of people across the globe. One of the keys to widespread consumer adoption of any technology is ease of use. To facilitate the ease of use of modern technologies, developers typically abstract the complex functions of a device into simple operations that can be performed by an end user. For instance, to print a document from a personal computer, a user must simply use a mouse and click a “printer” icon displayed on a computer screen while the document is being displayed. The computer's hardware and software then perform the relatively complex tasks of communicating with the printer, formatting the document to be printed, and transmitting the formatted document to the printer. Software and drivers on the computer or the printer also control the printer in a manner such that it can receive the formatted document from the computer and print the document. As is apparent, these tasks would be difficult to perform by all but the most knowledgeable computer users if the tasks were not abstracted into one simple mouse-click over an icon.

In the field of telecommunication devices, such as routers, however, such abstractions have generally not taken place. Rather, automated software programs or complex manual procedures are typically used to configure and mange these devices. For instance, when a consumer purchases a router to control the communication between computers in a home network and/or an outside network, such as the Internet, software often ships with the router to configure the router automatically. The user inputs a few basic pieces of information, such as the type of Internet connection the user has, and the software attempts to automatically configure the router to work properly based on that information. Such software can have several problems, however. First, the software is generally not able to configure any but the most basic settings and options available on the router. As such, many of the features of the router go unused. Second, and more frustrating for consumers, the software often does not function properly, leaving the router improperly configured or even in a non-functional or inoperable state.

Aside from such automated software, telecommunication devices may have user interfaces that permit a user to change the settings of the devices manually to configure the devices for use. Such interfaces, however, also have a critical shortcoming. Because the settings of telecommunication devices generally have not been abstracted in a manner to facilitate ease of use, the user interface itself simply presents the various settings of the device to the user for the user to change at will. The user therefore must be extremely familiar with the different settings of the device in order to edit them properly to configure the device as intended. For instance, a user might have a first wireless router connected to the Internet and a second wireless router attached to the user's computers. The user, logically, might want to configure the routers so that the computers could connect to the Internet. The user would therefore need to setup a wireless bridge between the first and second wireless routers. Setting up a wireless bridge, however, may require the user to change 20 or 30 different settings on the second wireless router to configure it properly, and perhaps may require changing additional settings on the first wireless router as well. Each of these settings is related to a different function or service performed by the routers. Errors in the settings can be difficult to identify, and one wrong setting can mean the wireless bridge will not operate. As such, while the above mentioned setup may be desired by many computer users, only the most experienced users even attempt such a setup, and even fewer of those users are actually successful in establishing the wireless bridge.

These difficulties in setting up and using telecommunication devices have limited the adoption and use of such devices by consumers. For instance, few people are willing to purchase a router due to the intimidation most people face when setting up the device. Even when consumers purchase telecommunication devices, other major problems are experienced by the telecommunication industry that stem from users' inabilities to setup and configure their devices. For instance, calls from customers having problems configuring and using their devices are extremely common and, due to the complexity of the configuration procedures for the devices, very time consuming and costly to handle. More problematic, inabilities to properly configure such devices lead to very high rates of returns, and in some cases can even damage the devices.

### SUMMARY

The present embodiments overcome these and other deficiencies of the prior art by providing systems and methods that easily interface with, configure, and manage embedded devices, such as telecommunication devices, and that interface with, configure, and manage networks equipped with such embedded devices. In some embodiments, a system comprising a graphical user interface with common abstractions for the settings of an embedded device is presented to a user. In some embodiments, the abstractions are displayed to the user as intuitive icons. In some embodiments, these icons use pictures, colors, and/or other graphical and animation techniques to illustrate device management functions to a user. Using embodiments, the user is able to easily determine how he/she wants the embedded device configured, and can also quickly configure the device in that manner without having to be familiar with the underlying settings of the device. Further, the user can use the interface to manage the device by changing settings or uses of the device as necessary. In some embodiments, the system and its graphical user interface acts as a “'skin” over an existing legacy user interface of the embedded device, permitting the system to be easily implemented on top of essentially any embedded device with a web server. Furthermore, the system can be used to implement and manage networks of embedded devices using the same methods disclosed herein.

In some embodiments, an embedded device is provided. The embedded device, in some embodiments, includes an interface that interacts with the device to configure the device, a server configured to receive requests for execution by the server using the interface and transmit responses to those requests; and a graphical user interface system. The graphical user interface system, in some embodiments, is configured to receive an incoming request pertaining to the device, generate an outgoing request in response to the received request, transmit the outgoing request to the server; and receive from the server a response to the outgoing request generated after execution of the outgoing request by the server using the interface. In some embodiments, the outgoing request is mapped to the interface. In some embodiments, the received response is used by the system to generate and transmit a new response to a user of the embedded device. In some embodiments, the interface configures the embedded device based on the outgoing request. In some embodiments, the incoming request is an XML request, while in other embodiments, the incoming request is a Java call. In some embodiments, more than one response is received in response to the outgoing request. According to some embodiments, the responses are received from more than one embedded device. In some embodiments, the system generates more than one outgoing request in response to the received request. In addition, in some embodiments, the outgoing requests are generated as a result of an abstraction of a complex embedded device configuration into a single one-click icon of a second interface of the system. In some embodiments, the outgoing requests are transmitted to more than one embedded device. In addition, in some embodiments, the system is further configured to transmit the received response to a user of the embedded device. In an embodiment, the received response is included within a frame of a second interface of the system. In some embodiments, the frame includes more than one received responses.

In some embodiments, a method for configuring an embedded device is provided. In some embodiments, the embedded device includes an interface that interacts with the embedded device to configure the embedded device and a server configured to receive requests for the interface and transmit responses to the requests after execution of the requests by the server using the interface. In some embodiments, the method includes receiving at a graphical user interface system, via a data-transmission network, an incoming request pertaining to the embedded device, storing the incoming request in a computer-readable medium of the embedded device, generating at the graphical user interface system an outgoing request in response to the received request, transmitting the outgoing request from the system to the server; and receiving at the graphical user interface system, from the server, a response to the outgoing request after execution of the outgoing request by the server using the interface. In some embodiments, the outgoing request is mapped to the interface. In some embodiments, the method includes using the received response to generate and transmit a new response to a user of the embedded device. In some embodiments, the method includes configuring the embedded device based on the outgoing request. In some embodiments, the incoming request is an XML request, while in other embodiments, the incoming request is a Java call. In some embodiments, the method also includes receiving more than one response in response to the outgoing request. In some embodiments, the responses are received from more than one embedded device. In some embodiments, the method also includes generating more than one outgoing request in response to the received request. In some embodiments, the outgoing requests are generated as a result of an abstraction of a complex embedded device configuration into a single one-click icon of a second interface of the system. In some embodiments, the requests are transmitted to more than one embedded device. In some embodiments, the method also includes transmitting the received response from the system to a user of the embedded device. In other embodiments, the method also includes including the received response within a frame of a second interface of the system. In some embodiments, the frame includes more than one received response.

In other embodiments, an embedded device is provided that includes a first system server and a second system server with an interface. In some embodiments, the first system server is configured to receive an incoming request from a client of the embedded device, generate an outgoing request in response to the incoming request, transmit the outgoing request to the interface, receive a generated response, map the generated response to a response expected by the client and transmit the mapped response to the client. In some embodiments, the outgoing request is mapped to an interface of the embedded device. In some embodiments, the second system server is configured to receive the outgoing request from the first system server, execute the outgoing request using the interface to configure the embedded device and generate the response to the outgoing request, and transmit the generated response to the first system server.

### BRIEF DESCRIPTION OF THE DRAWINGS

For a more complete understanding of the present embodiments, the objects and advantages thereof, reference is now made to the following descriptions taken in connection with the accompanying drawings in which:

FIG. 1 depicts a prior art legacy graphical user interface for a telecommunications device.

FIG. 2 depicts a prior art system status display for a telecommunications device.

FIG. 3 depicts a graphical user interface as displayed in a browser window according to one embodiment.

FIG. 4 illustrates a dynamic status bar of a graphical user interface according to an embodiment.

FIG. 5 illustrates a graphical user interface according to an embodiment.

FIG. 6 depicts a graphical user interface according to an embodiment.

FIG. 7 illustrates a first, dynamic instance of a graphical user interface, according to an embodiment.

FIGS. 8-9 illustrate in detail icons of a graphical user interface according to various embodiments.

FIG. 10 depicts the architectural structure of a system according to an embodiment.

FIG. 11 illustrates an informational screen of a graphical user interface prior to the user clicking an icon, according to an embodiment.

FIG. 12 depicts content from a legacy user interface displayed within a frame of a graphical user interface according to an embodiment.

FIG. 13 depicts content provided by a legacy user interface with setup fields displayed within a frame of a graphical user interface, according to an embodiment.

FIG. 14 depicts a system providing parameter defaults for fields of a legacy user interface, according to an embodiment.

FIG. 15 depicts a “scrollable” frame of a graphical user interface according to an embodiment.

FIG. 16 depicts a graphical user interface during rebooting of en embedded device, according to an embodiment.

FIG. 17 illustrates an XML technology map according to an embodiment.

FIG. 18 depicts a system mapping to an embedded device according to an embodiment.

FIG. 19 illustrates the interaction between an end user, a system, and an embedded device according to an embodiment.

FIG. 20 illustrates the interaction between an end user, a system, and an embedded device according to an embodiment.

FIG. 21 illustrates a process flow diagram of a system according to an embodiment.

FIG. 22 illustrates integrated site management according to an embodiment.

FIG. 23 illustrates integrated site management according to an embodiment.

FIG. 24 depicts an explosion of the internal architecture of a system according to an embodiment.

FIG. 25 depicts a mapping process for a system according to an embodiment.

FIG. 26 depicts a mapping process for a system according to an embodiment.

FIG. 27 illustrates depicted an event, condition, action flow diagram of a system according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION OF THE DRAWINGS

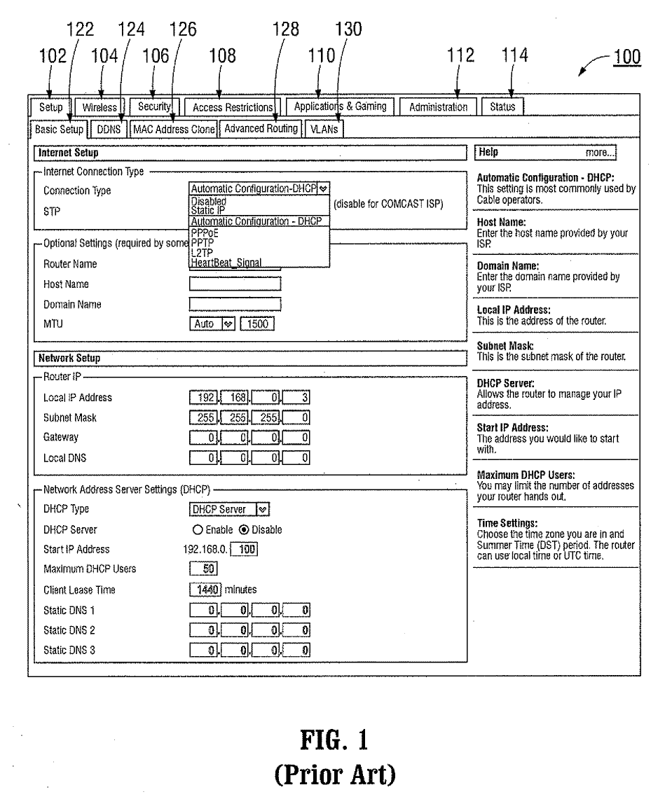

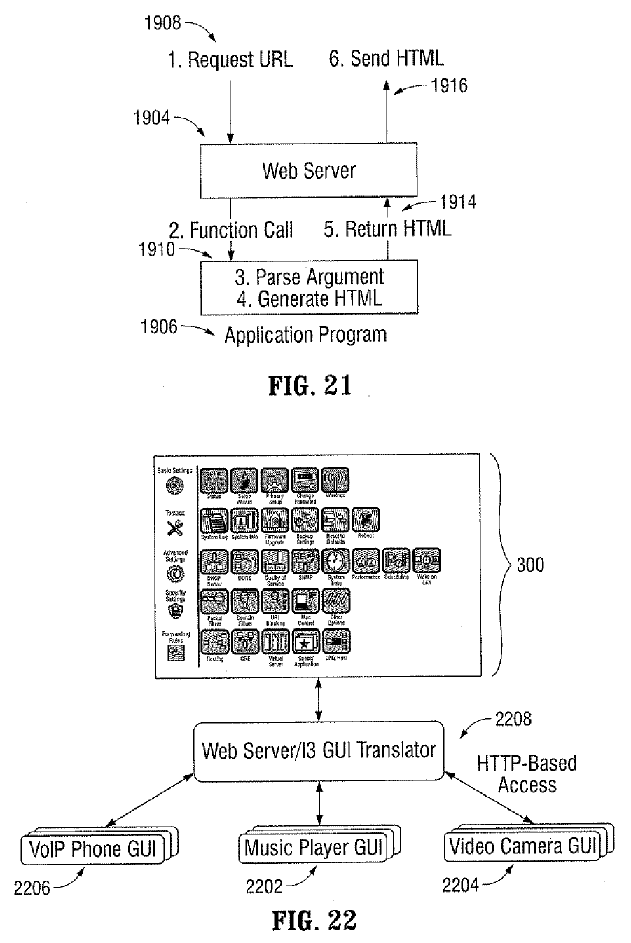

Further features and advantages of the present embodiments, as well as the structure and operation of the various embodiments, are described in detail below with reference to the accompanying FIGS. 1-27. The embodiments are described in the context of a system with a graphical user interface for use in conjunction with a router. Nonetheless, one of ordinary skill in the art readily recognizes that these embodiments are applicable in numerous fields and contexts which require abstraction of communication settings into a user friendly form, such as a user interface for a personal computer, network switch, web server, etc. The various embodiments are also applicable to other devices, such as a network appliance (e.g., a refrigerator or microwave) or other embedded devices.

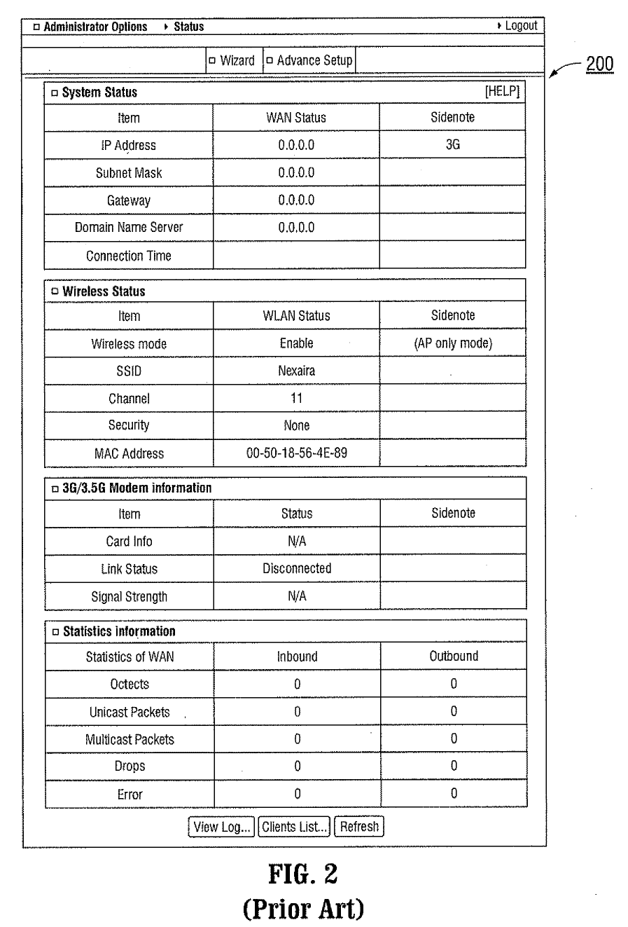

Referring first to FIG. 1, shown is a prior art legacy user interface 100 for a telecommunications device. In this case, the device is a router. The legacy user interface 100 comprises seven main tabs 102-114, each tab corresponding to an allegedly related group of settings for the device. As depicted in FIG. 1, the legacy user interface 100 comprises a setup tab 102, a wireless tab 104, a security tab 106, an access restrictions tab 108, an applications & gaming tab 110, an administration tab 112, and a status tab 114. When a main tab 102-114 is selected, a plurality of subtabs are displayed, each corresponding to a more specific group of settings for the main tab. For example, setup tab 102 comprises subtabs 122-130, each corresponding to a more specific group of setup related settings. More specifically, setup tab 102 comprises a basic setup subtab 122, a DDNS subtab 124, a MAC Address Clone subtab 126, an Advanced Routing subtab 128, and a VLANs subtab 130. Each substab, for each main tab, displays various settings to the user of the telecommunications device. These settings can then be changed by the user to configure the device. For example, when basic setup subtab 122 is selected by the user, settings for the a) internet setup, such as internet connection type, STP, router name, host name, domain name, and MTU; and b) network setup, such as router IP address, subnet mask, gateway, local dns, DTHCP type, DHCP server, start IP address, maximum DHCP users, and client lease time are displayed and editable by the user to configure the device. As is readily apparent, even under the basic setup subtab 122, the device settings are relatively technical and potentially confusing. Furthermore, given the extensive number of tabs 102-114 and subtabs (not all shown) of the legacy user interface 100, it is easy to see how an inexperienced user can quickly become confused with the number of settings available, and may not know under which tab/subtab a specific setting is located. Referring now to FIG. 2, depicted is a prior art status display 200 for a telecommunications device that is commonly used in conjunction with the legacy user interface 100 of FIG. 1. Like the legacy user interface 100, the status display 200 contains a multitude of complex and potentially confusing information for a user of the device. In addition, such display is generally not configurable by the user of the telecommunications device.

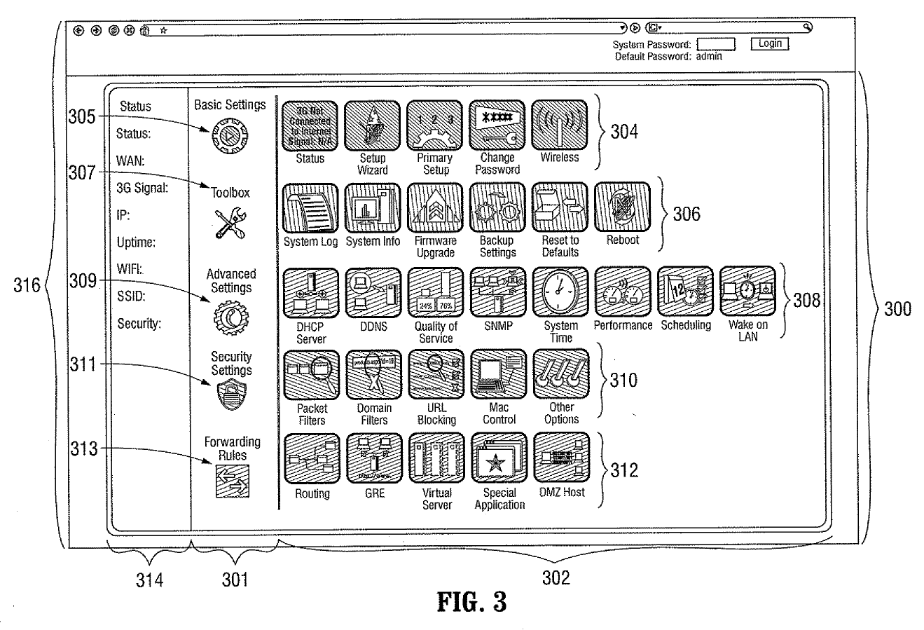

Referring now to FIG. 3., depicted is a graphical user interface 300 of a system according to one embodiment. The graphical user interface 300, in some embodiments, is displayed in a browser window 316 of a browser application. As shown in the present example, the graphical user interface 300 inhabits a defined area within the browser window 316. In some embodiments, the graphical user interface 300 occupies substantially all of a viewable area within the browser window 316. However, in various other embodiments, the graphical user interface 300 or other portions of the graphical user interface 300 will occupy less than the viewable area or more than the viewable area such that scroll bars are needed to view the entirety of the graphical user interface 300. In other embodiments, the graphical user interface 300 is not even visibly bounded by the browser window 316. Thus, the graphical user interface 300 can be used in a “full screen” mode, where only the graphical user interface 300 is visible to a user on his or her PC screen.

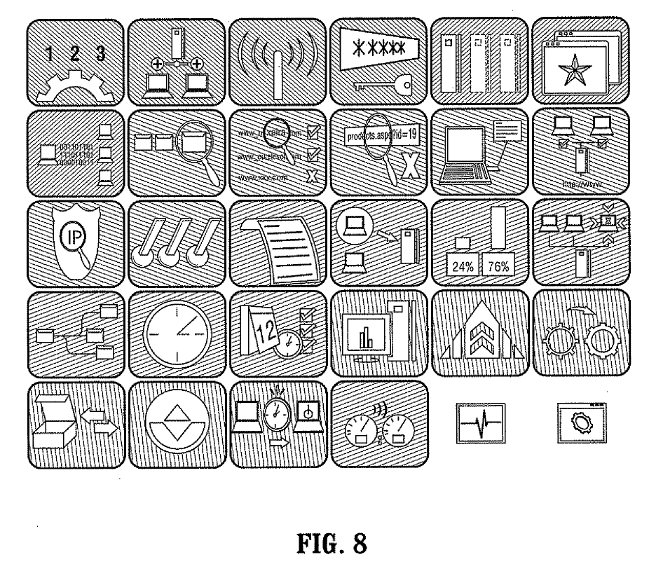

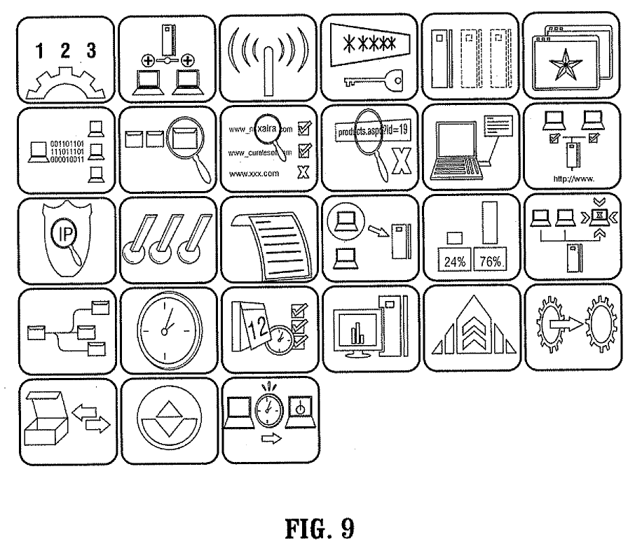

The graphical user interface 300, in some embodiments, comprises a settings panel 302, a key 301, and a dynamic status bar 314. The settings panel 302 comprises a plurality of icons (discussed in more detail below with reference to FIGS. 8 and 9). According to one embodiment, the icons are grouped according to their function. In addition, in some embodiments, the grouping is identified by the key 301. For instance, the Status, Setup Wizard, Primary Setup, Change Password, and Wireless icons are all grouped in the Basic Settings group 304. This group is readily apparent to the user because these icons, in some embodiments, are all horizontally adjacent to the Basic Settings group identifier 305 in the key 301. In addition, in some embodiments, the icons in a group and their corresponding identifier in the key 301 all share the same unique color. (Note: colors in the figures are indicated by hatchings. Icons with the same color have the same hatching). For example, the icons in the Basic Settings group 304 are all green, and the Basic Settings group identifier 305 in the key 301 is also green. This same grouping scheme can be applied for the remaining groups 306-312 of the settings panel 302, and their corresponding group identifiers 307-313 in the key 301. Thus, for example, the icons in the Forwarding Rules group 312 are horizontally adjacent to and the same color, orange, as the Forwarding Rules group identifier 313, and the icons in the Security Settings group 310 are horizontally adjacent to and the same color, purple, as the Security Settings group identifier 311 in the key 301, and so on.

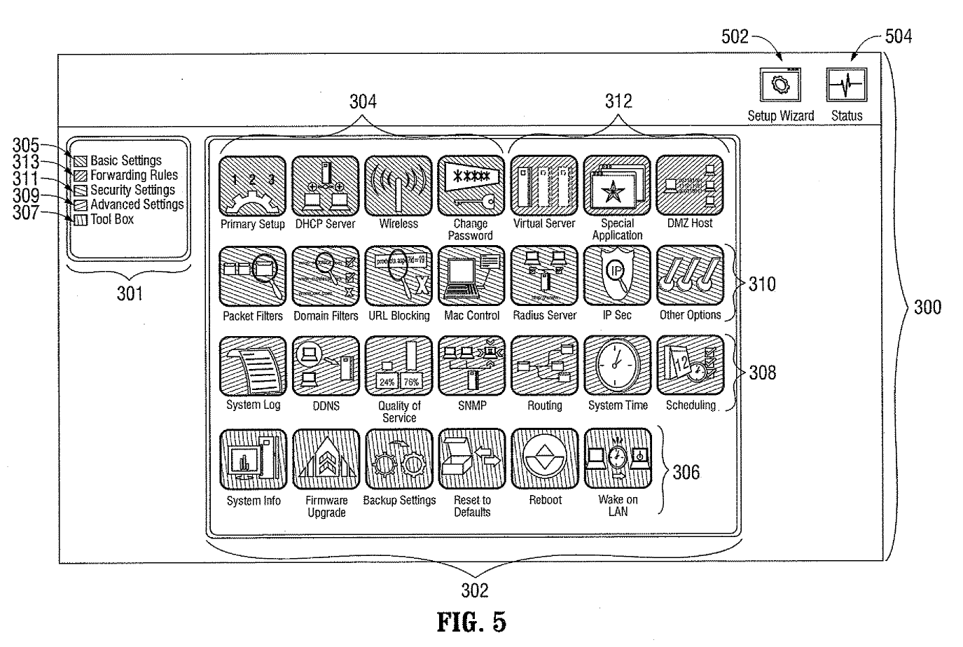

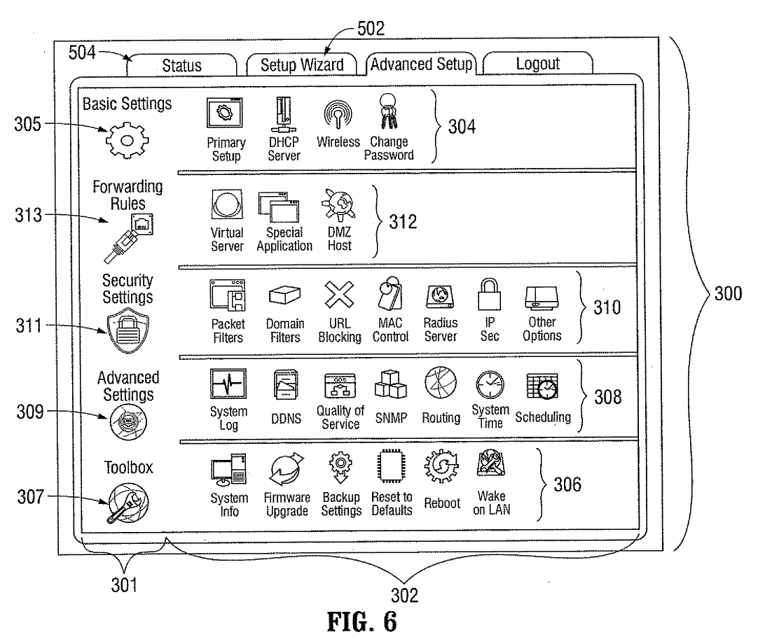

In some embodiments, icons can be grouped using methods unrelated to their color or position. For instance, in one embodiment (not shown) the icons are grouped based on the background of the settings panel 302. For instance, the background of the settings panel 302 can have a different color or a different design behind each group of icons. In another embodiment (not shown), a simple square or similar geometric shape is placed around the group of icons to indicate that they form a group. Referring briefly now to FIG. 5, in another embodiment for example, the icons are grouped solely by color and the group identifiers 305-313 are simply color coded in the color corresponding to their group 304-312. Referring briefly now to FIG. 6, in one embodiment, for example, the groupings of icons are delineated by simple horizontal lines.

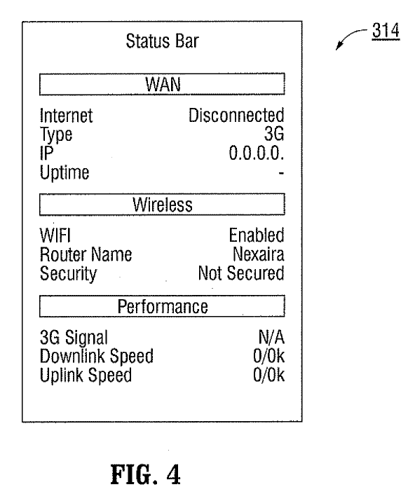

Referring now to FIG. 4, depicted is a dynamic status bar 314 according to one embodiment. The dynamic status bar 314 displays current status information of the device, such as whether the device is connected to the internet, the device's IP address, the type of wireless connectivity enabled, and so on. In some embodiments, the status bar 314 updates in real time based on the current status of the device. Thus, if the device is suddenly disconnected from the Internet, the Internet status on the status bar 314 will change from “connected” or “10 MBs,” etc. to “Disconnected.” In some embodiments, the status bar 314 is configurable using the methods disclosed herein, and therefore can be customized to display only the information deemed important to the user. In addition, the status bar 314, in some embodiments, remains stationary regardless of the icon selected by the user. As such, a user will always have quick access to the most critical information pertaining to the device without having to navigate to a different tab or page.

Referring now to FIG. 5, illustrated is a graphical user interface 300 according to another embodiment. The graphical user interface 300 comprises an automated setup wizard 502 and a status display icon 504. The automated setup wizard 502 performs functions similar to that of the automated setup program already discussed. Importantly, however, the automated setup wizard 502 leverages the abstractions that have been developed that correspond to the complex settings and configurations of the embedded device (discussed in detail below), thereby permitting much more advanced setups to be achieved. For example, in some embodiments, a user must merely choose between different icons and their corresponding abstractions to advance and eventually complete the setup wizard. The status display icon 504 retrieves a display of information corresponding to the configuration and function of the device that is pertinent to the user, and operates and is configurable like the dynamic status bar (not shown) previously discussed.

Referring now to FIG. 6, depicted is a graphical user interface 300 according to an embodiment. As is apparent, the graphical user interface 300 comprises the same elements as previously discussed, only in a different configuration. In addition, as discussed above, the icons depicted are not color coded.

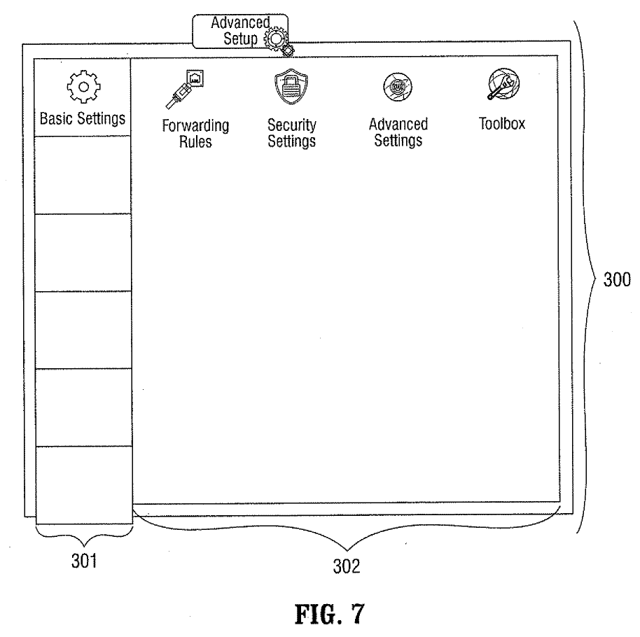

Referring now to FIG. 7, depicted is a first, dynamic instance of a graphical user interface 300, according to an embodiment. In some embodiments, the icons displayed to the user are dynamic, or can be configured by the user. For instance, as depicted in FIG. 7, the first time a user views the graphical user interface 300, only basic icons are displayed to the user. This is because many advanced settings and configurations cannot be setup until the more basic embedded device settings have been established. Once the user utilizes the icons to configure the basic settings of the device, additional icons, corresponding to more advanced configurations, will be displayed by the graphical user interface 300. In addition, in some embodiments, the user can configure the graphical user interface 300 using the methods disclosed herein to only display certain icons.

FIG. 8 and FIG. 9 illustrate in detail icons of a graphical user interface according to various embodiments. The icons shown are only exemplary, and those of ordinary skill in the art will recognize that the type of icons displayed by the graphical user interface will depend on the type of embedded device be configured and a user's current settings. Each icon corresponds to an abstraction of the settings and configurations for the embedded device. For example, the URL Blocking icon performs all the functions necessary to block specific URL from being visited by users of the embedded device; the user must simply specify the URL. A similar icon entitled Wireless Bridge (not shown), for example, automatically establishes a wireless bridge between two wireless routers. In some embodiments, when an icon is clicked by a user, the abstraction of the icon is executed, and the embedded device is configured as suggested by the icon and as desired by the user. In other embodiments, the main page (not shown) of the graphical user interface is cleared and the user is given options to complete the abstraction. These options, in some embodiments, take the form of additional icons, while in other embodiments they are simply pull down tabs, text boxes, or radio buttons. Once the user provides these necessary details, the embedded device is configured and the main page of the graphical user interface is restored, displaying all of the icons, as depicted in FIG. 3, or a dynamically selected portion of the icons, as depicted in FIG. 7.

In some embodiments, an icon's abstraction is not only specified by the text of the icon, but also by the icon's image, animation, group, etc. For example, an icon's image can be designed to evoke thoughts of familiar computer representations in the mind of a user, such as a mouse or computer screen, to guide the user in the selection of an icon to perform a specific function. In addition, the icons can be animated, further illustrating the function they perform. For example, when a user moves his/her mouse over the icon, the icon becomes animated and depicts the function it will perform if clicked. Such functionality is implemented, for example, with animated Flash or with animated GIFs in conjunction with mouse-over JavaScript code embedded in an HTML page. In other embodiments, the color and groupings of the icons also correspond to the abstraction performed by the icon. For instance, icons that are green, a “calm” color, perform basic functions, while icons that are red, a color that evokes caution, perform advanced, potentially confusing functions. In this manner, users who are entirely unfamiliar with configuring the underlying embedded device can easily understand the function an icon will perform and can successfully configure the device without any prior knowledge of the functionality of the device and without having to read an instruction manual. In some embodiments, an icon and its corresponding abstraction is continually refined through field trials and customer feedback. In some embodiments, the precise settings an icon's abstraction sets, along with the design, layout, etc. of the icon itself are dynamic and/or can be varied to best meet the needs of the user. These variations, in some embodiments, are specified by the user. In other embodiments, these variations are determined by the developers of the graphical user interface through the aforementioned feedback with other users. In some embodiments, the design or abstraction of an icon can be updated with a system, such as via a firmware update downloaded from the Internet.

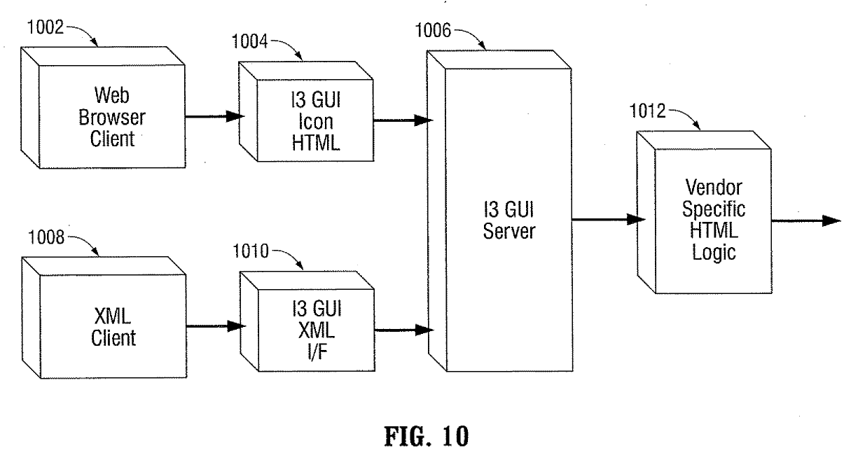

Referring now to FIG. 10, depicted is the architectural structure of a system according to an embodiment. As depicted, in some embodiments the system and its interface(s) 1004, 1010 are designed as a “skin” to operate in conjunction with an embedded device's existing management software/firmware 1012. Thus, in these embodiments, the system and its interface(s) 1004, 1010 replace or work in conjunction with the legacy user interface found with the software/firmware 1012, but still utilize the underlying software/firmware 1012 to control the operation of the embedded device. In some embodiments, the user interacts with the interface(s) 1004, 1010 of the system, while the underlying software/firmware 1012 of the embedded device controls the operation of the device. These embodiments are now discussed in more detail.

The embedded device, in some embodiments, comprises a basic legacy web server and/or related applications to permit a user to interface with and configure the device and to allow for execution and transfer of legacy user interface data to a user. For instance, when a router is part of a local network, a user can often type the address “http://192.168.0.1” into his/her browser client 1002 and connect to the router's legacy web server. The router's legacy web server then transfers legacy user interface data to the user to be displayed by the web browser client 1002. Utilizing the legacy user interface, the user can then configure the device.

According to some embodiments, a system comprising the graphical user interface also comprises one or more servers that communicate with the device's legacy web server. For instance, when a user utilizes a browser client 1002, the browser client 1002 displays system generated icons and/or html 1004 communicated over a network or similar communications channel from the system server 1006. Thus, referring to FIG. 3, a user would type in the address “http://192.168.123.254” for example, into his/her browser and connect to one of the system's web servers and interact with the graphical user interface 300. Referring back to FIG. 10, in other embodiments, when an XML client 1008 is utilized, the XML client 1008 communicates with a system server 1006 using a system generated XML interface (“I/F”) 1010. In some embodiments, the system then maps the incoming communications from the browser client 1002 and/or XML client 1008 to requests that can be handled by the legacy user interface of the software/firmware 1012 of the embedded device and then transmits those requests to the server of the legacy device for execution by the software/firmware 1012, and more particularly, in some embodiments, by a legacy user interface.

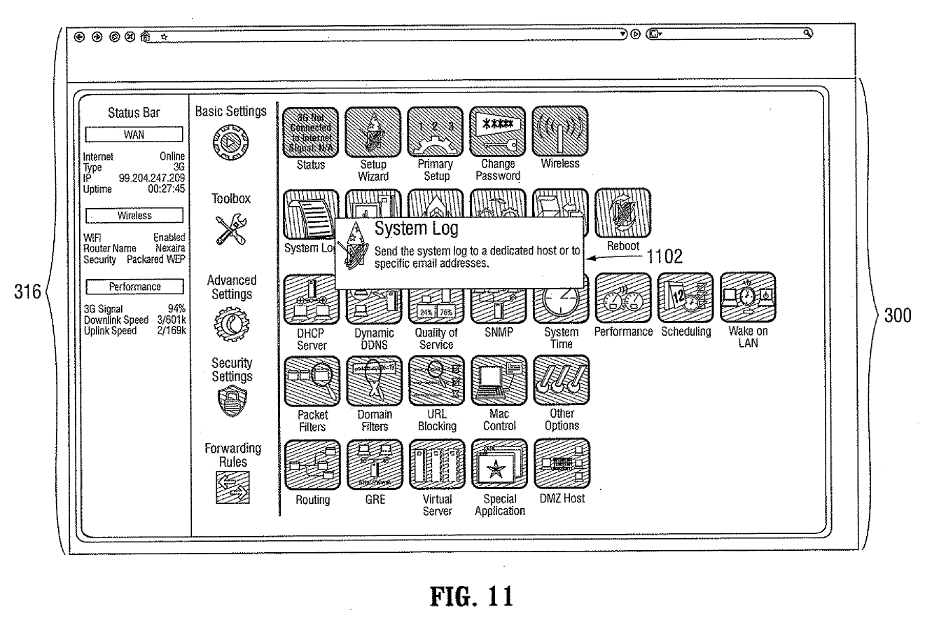

Referring now to FIG. 11, in some embodiments, when the user positions his/her mouse over an icon of the graphical user interface 300, advanced self help information is provided in an information screen 1102 to inform the user about the functions the icon will perform. When the user clicks the icon, a request (sometimes referred to herein as a “call” or an “HTML call” in the context of standard HTML requests) is transmitted from the user to the system to perform the icon's abstraction. The system receives the request and then performs the icon's abstraction. In some embodiments, the icon's abstraction is performed by displaying to the user a different set of icons or another portion of the graphical user interface 300. In other embodiments, the icon's abstraction is performed by generating one or more requests configured for the legacy user interface and transmitting those requests, via one of the system's servers to the device's legacy server, to the legacy user interface (this process, or portions thereof, is sometimes referred to herein as “mapping”). The embedded device's legacy server, and in turn legacy user interface, receives these requests and generates responses as normal. Thus, for instance, if the legacy user interface receives a request to change a setting of the embedded device, the legacy user interface does so according to its standard operating methods. Using this method, the embedded device is configured according to the requests generated by the system and/or content is provided by the legacy user interface to the graphical user interface 300 pursuant to those requests.

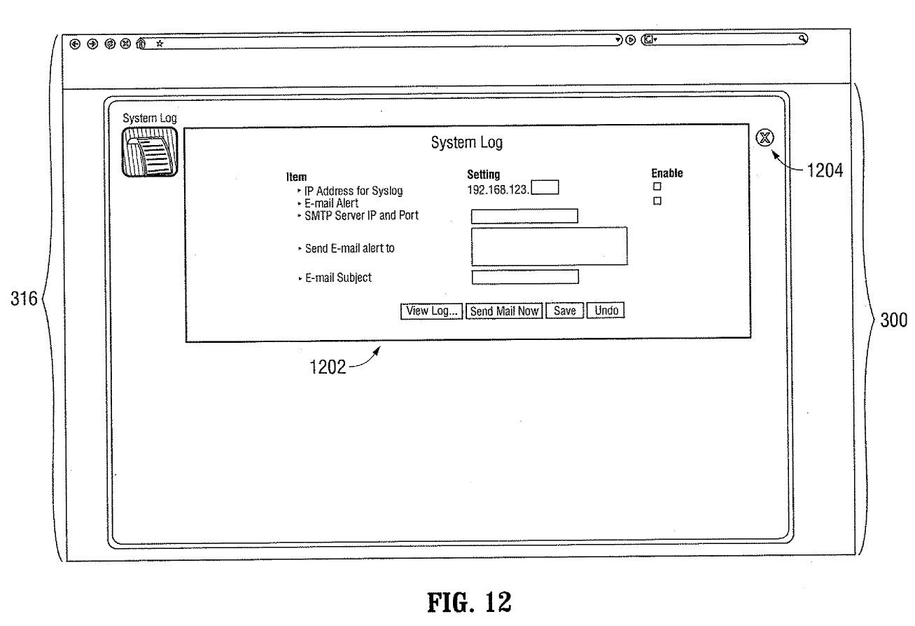

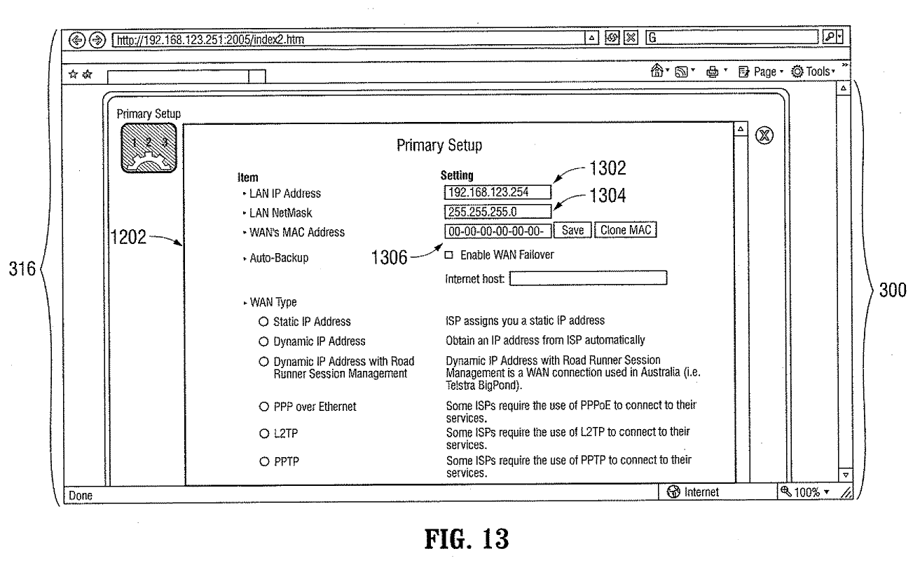

Referring now to FIG. 12, in some embodiments, content, such as a webpage, that is provided by the legacy user interface is displayed within a frame 1202 of the graphical user interface 300. An “X” or similar item 1204 of the graphical user interface 300 is also displayed to the user and returns the user to a home page (not shown) of the graphical user interface 300 if it is clicked. Thus, content from both the legacy user interface and the graphical user interface 300 can be displayed to a user simultaneously. In some embodiments, the content provided by the legacy user interface is simply used to generate new content within the frame 1202 or elsewhere, such as the status bar or settings panel (neither shown). In other embodiments, the content from the from the legacy user interface is provided in the frame 1202 “as is.” In some embodiments, the content provided by the legacy user interface is formatted, edited, or otherwise integrated into the content of the graphical user interface 300 and the system. For instance, referring to FIG. 13, depicted is content provided by a legacy user interface displayed within frame 1202 of the graphical user interface 300. This legacy content includes setup fields 1302, 1304, and 1306. In some embodiments, since mappings of the system provide the relevant information for each setup field 1302, 1304, and 1306, that information is automatically added to the fields for display to the user and for easy configuration of the embedded device. Any changes to these fields, in some embodiments, are validated by the system using the system's mappings. In addition, such mappings permit content provided by the legacy user interface to be modified, edited, or utilized in any manner to ensure the content is properly displayed properly within the frame 1202 or is otherwise consistent with the design and implementation of the graphical user interface 300.

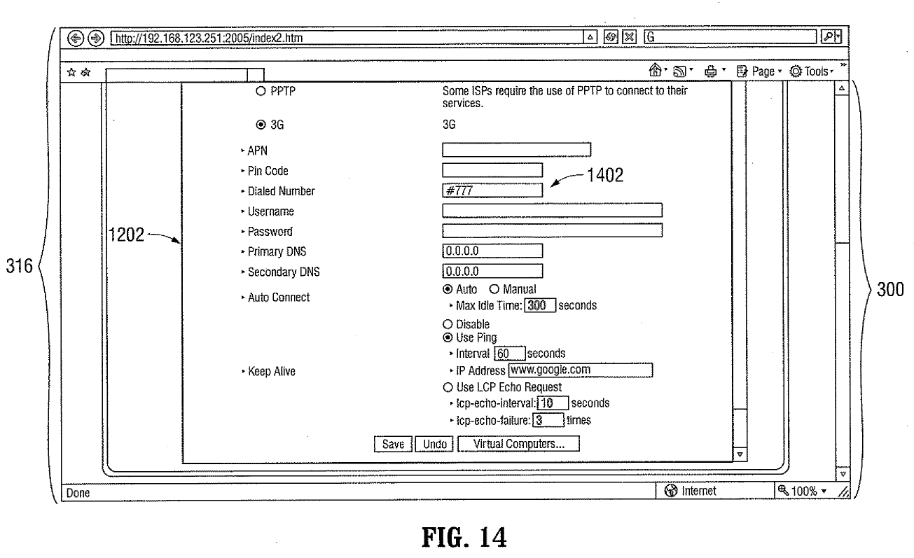

Referring now to FIG. 14, depicted is a system providing parameter defaults for fields of a legacy user interface, according to an embodiment. For example, content provided by the legacy user interface includes a “Dialed Number” field 1402. Using the system's mappings, the content for this field 1402 automatically defaults to #777. In some embodiments, the system automatically sets the defaults for legacy fields. In other embodiments, a drop-down menu containing appropriate parameters for the legacy fields is provided to the user, thereby permitting the user to select from a number of appropriate parameters for a given legacy field. The legacy fields and parameter mappings displayed need not be limited to a single embedded device. Thus, fields and parameters pertaining to different embedded devices can be displayed on screen simultaneously for easy access and modification by the user, thereby permitting management of a plurality of networked embedded devices using a single graphical user interface 300.

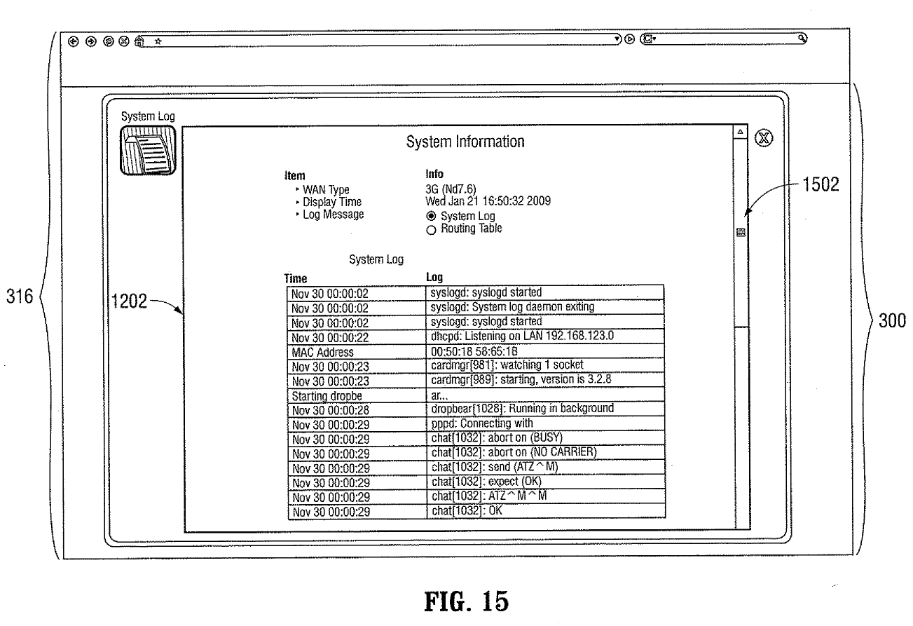

Referring now to FIG. 15, in some embodiments the frame 1202 of the graphical user interface 300 is expandable or is “scrollable” using a scroll bar 1502. Thus, content that would not normally fit within the frame 1202 can still be easily viewed by the user of the graphical user interface 300. In addition, in some embodiments, as discussed above, content from multiple legacy user interface responses are combined into the frame 1202, therefore permitting the graphical user interface 300 to efficiently display disparate or large amounts of information in a convenient and user friendly manner. In some embodiments, the frame is implemented using standard HTML techniques, while in other embodiments Flash is used to create the frame.

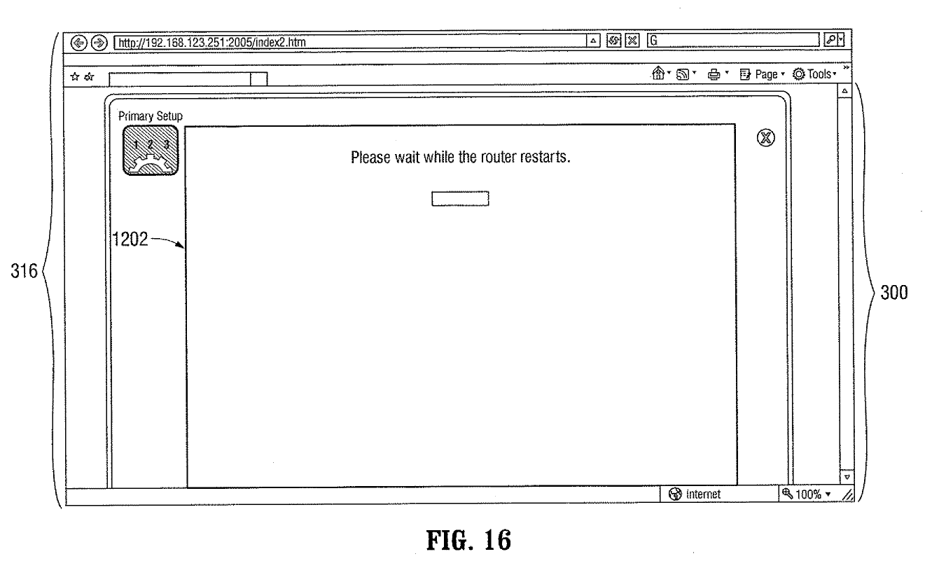

Referring now to FIG. 16, in some embodiments, the various parameters specified by the system mappings or input by a user of the graphical user interface 300 require the underlying embedded device to reboot and re-initialize itself. In some embodiments, the parameters specified by the system or the user are sent using the legacy web server (via the legacy user interface) or the system web server to multiple other networked embedded devices. Such a process thus effectuates configuring or re-initializing an entire network of embedded devices using the same methods discussed above with respect to a single embedded device. In some embodiments, the system controls the time out of when to attempt to re-display the main menu again after an embedded device restart. After the embedded device(s) have re-booted or otherwise re-initialized, an updated home screen such as that depicted in FIG. 3 is displayed to the user which reflects the recent changes made to the embedded device(s).

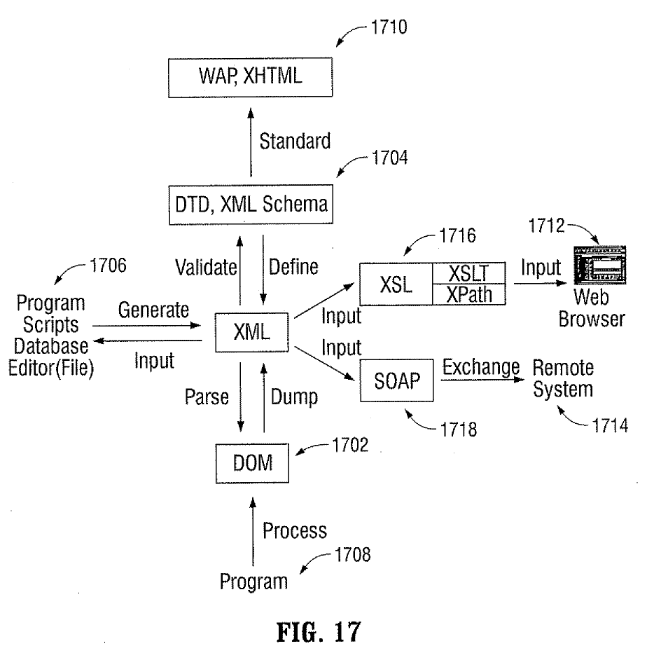

In some embodiments, the “skin” operates by way of an XML structured architecture. Referring now to FIG. 17, depicted is an XML technology map according to an embodiment. Put simply, XML is a specification that permits the creation of custom markup languages. The interaction of one or more document object models 1702 with schemas 1704 and scripts, database files, or editor files 1706 using the XML specification permits easy translation of information for use by different programs 1708, to meet varying standards 1710, to be used by different web browsers 1712, or to be translated and exchanged with other various remote systems 1714. A document object model 1702 is a standard object model for representing HTML or XML documents. The document object model 1702, in some embodiments, is also an APT that permits querying, traversing, and manipulating such documents. XML schemas 1704 provide the descriptions of the types of XML documents to be used by the system, such as the constraints on the structure of the documents and the contents of the documents. The programs, scripts, database files, or editor files 1706 control and define how documents are manipulated using the document object model 1702 and schemas 1704. Extensible stylesheet language (“XSL”) 1716 provides a family of transformation languages that describe how to format or transform the system documents. SOAP 1718 is a protocol that utilizes XML to exchange structured system documents over a network.

In some embodiments, XML is not management domain specific technology, and as such is easy to learn. In addition, there is a significant amount of support tools and technology available for use with XML, permitting low development costs. XML is also highly compatible with legacy management technology, in some embodiments permitting integrated management of the graphical user interface and the underlying telecommunications device. In addition, XML has a low footprint meaning, in some embodiments, the data for implementing the graphical user interface and/or the system is stored in the memory of the embedded device. Such low footprint permits embodiments to be used in a wide range of applications and to be used to layer advanced graphical or web technologies on almost any embedded hardware system, such as with a portable wireless router. In some embodiments, the XML structured architecture of the graphical user interface can be layered on top of any embedded device hardware running Linux or any other operating system extensible by its users or comprising a web server, regardless of the device. This layering technique, in some embodiments, is cumulative. As such, in some embodiments, the system does not merely map between an icon and an existing legacy HTML function of the embedded device, but also between an XML call and an existing legacy function or a Java call and an existing legacy function.

Referring now to FIG. 18, depicted is a system and its user interface(s) mapping onto an embedded device 1802 according to an embodiment. For example, the graphical user interface 300 is implemented, in some embodiments, using JavaScript, CSS, and/or XML programming. In some embodiments, such programming is AJAX compliant. A dynamic HTML page or XML content is created that is viewable by any client device 1804 with a web browser or an XML client when the client device 1804 is directed to the system server(s) 1806. The system uses a set of mapping tools 1808 to map its functionality over the existing interface of the embedded device 1802, allowing the embedded device 1802 to take on a different look and feel for the user of the client device 1804, as previously discussed. In some embodiments, the mapping tools 1808 comprise an XML definition for the embedded device 1802, such as a router, and CSS files. In this embodiment, for example, XML files, simple flat files, or similar files are used to maintain the configuration of the embedded device 1802 and to determine the appropriate mappings. In some embodiments, the data of the system, including the graphical user interface, requires less than 300 Kilobytes of storage. In some embodiments, the system includes two kinds of servers 1806, a web server for HTML and related requests from the client device 1804, and a listener which cooperates with the web server for receiving and responding to XML and/or JavaScript client requests from the client device 1804. In some embodiments, the system itself is embedded on or otherwise operates from the embedded device 1802.

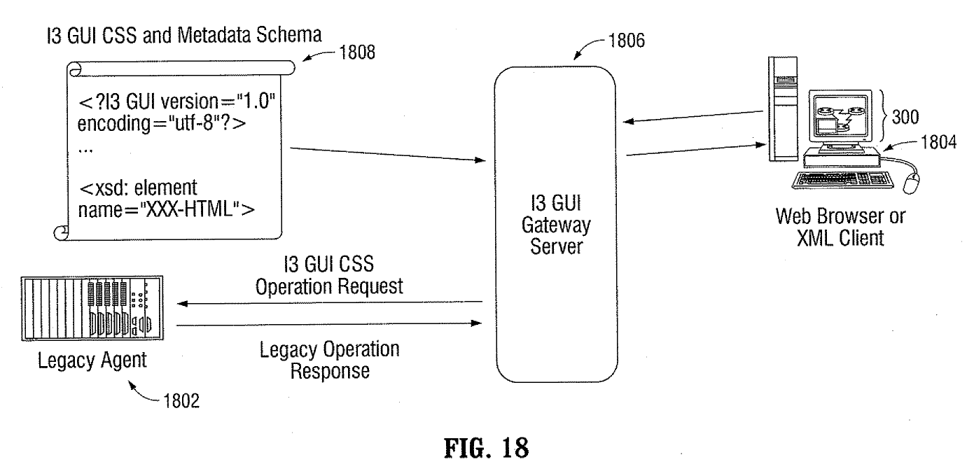

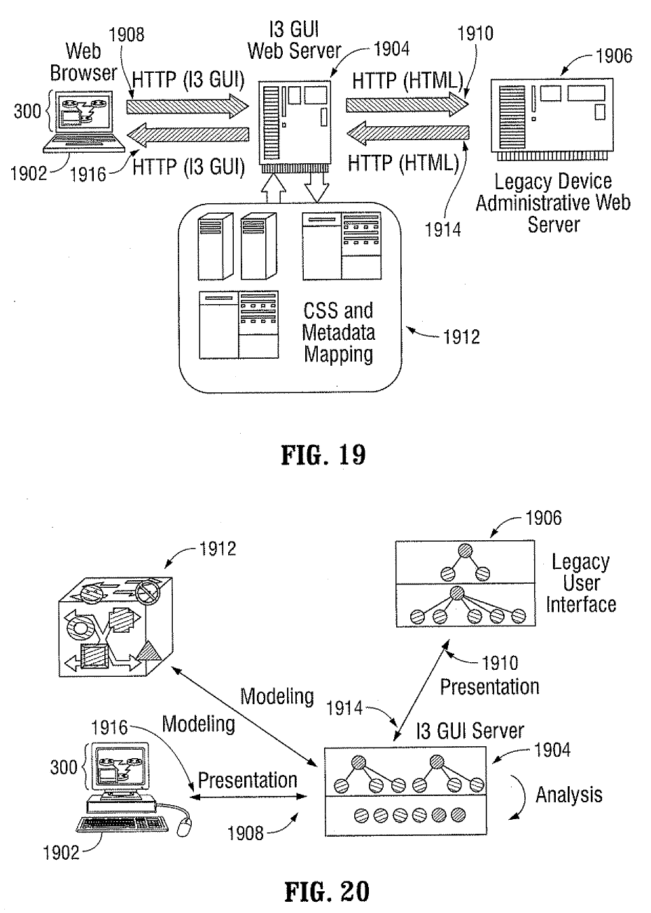

Referring now to FIGS. 19, 20, and 21, illustrated is interaction between an end user using a client device 1902, a system comprising at least one server 1904, and an embedded device 1906 according to various embodiments. In general, the interaction takes place as follows:

1. A request 1908 is made for information from a client device 1902: for example, the client may request 1908 an HTML page by having a user click on an icon of the graphical user interface 300, an XML client may provide an API request (not shown), or a Java Script client may provide an API request (not shown).

2. Analysis and Mapping: based on the client request 1908 received, the system decides what type(s) of requests 1910 need to be transmitted from the one or more servers 1904 to the embedded device 1906. In some embodiments, the requests 1910 are determined based on the model of the call representation that is returned by the embedded device 1906, or by the mapping files 1912 of the system. In some embodiments, in order to execute on the XML, icon click, or Java Script request 1908 being made, more than one HTML call must be made to the embedded device 1906 or be made to more than one embedded device (not shown), and then recombined into one presentation back to the requesting client 1902. In other embodiments, only one HTML call 1910 is necessary.

3. Requests and Responses: based on the analysis and mapping, in some embodiments, requests 1910 are issued to the embedded device(s) 1906, via the legacy user interface, and response(s) 1914 are received from the embedded device 1906. The response(s) 1914 from the embedded device 1906 are use to create remapped and formatted responses 1916 for the client device 1902. The responses 1916 are generated using the mapping files 1912 for the client device's 1902 API method (iconic response, XML response, or Java response). Finally, the remapped and formatted responses 1916 are transmitted from the server(s) 1904 to the client device 1902.

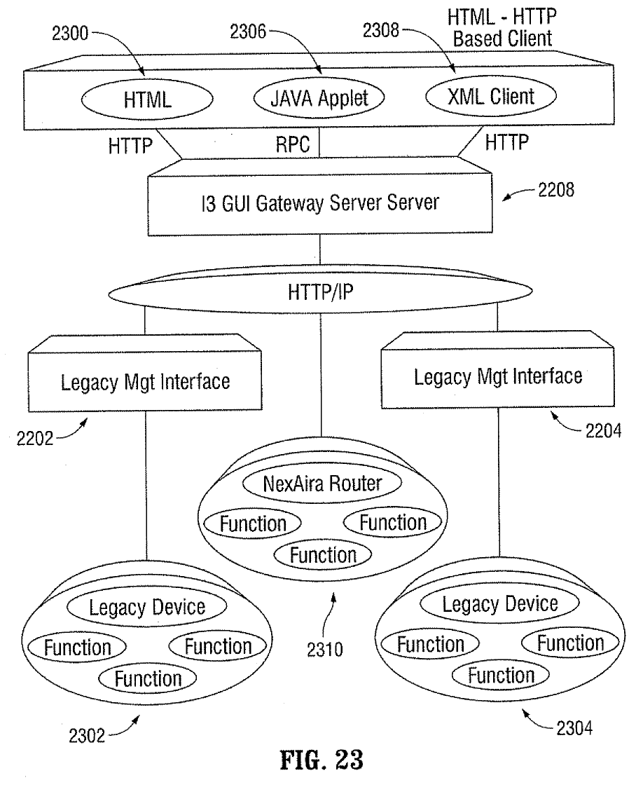

Referring now to FIGS. 22 and 23, illustrated is integrated site management according to various embodiments. This integrated management permits, for example, a plurality of legacy interfaces, such as music player interface 2202, video camera interface 2204, or VoIP telephone interface 2206 to interface with the server(s) 2208 of the system, and therefore the user, by creating a single iconic or XML or Java script invocable representation of the legacy interfaces 2202, 2204, 2206 in the graphical user interface 300. For example, if a particular location has a router configured with the graphical user interface 300, and that location also needs to manage a Music Player 2302 and a Video Camera 2304, then both of these devices can collectively be mapped, dynamically, by the system and displayed via the graphical user interface 300 to the end user as one or more icons as part of an HTML based webpage 2300, or as a collection of XML or Java Script calls for use by a Java Applet 2306 or XML client 2308. In addition, referring specifically to FIG. 23, the system, in some embodiments, is also directly integrated into its own non-legacy embedded device 2310, permitting the elimination of the legacy user interface and legacy web server altogether.

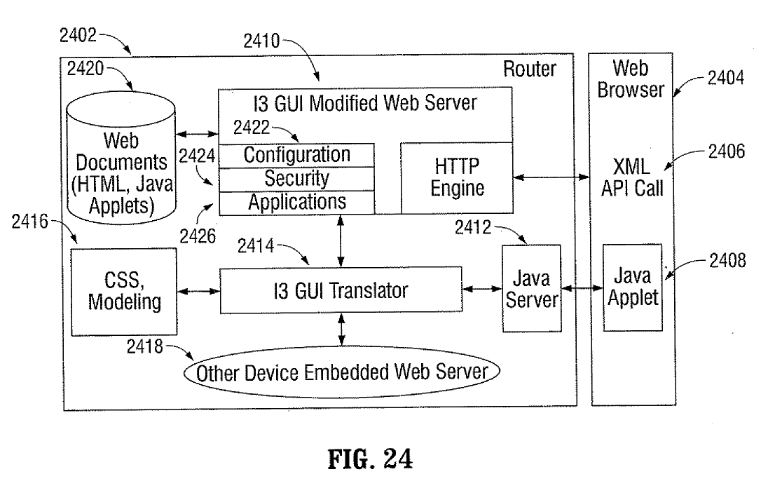

Referring now to FIG. 24, depicted is an explosion of the internal architecture of a system according to an embodiment. In some embodiments, such as that depicted, the system is a part of the embedded device 2402. For example, in some embodiments the software code of the system, including the code for the server(s) 2410 and 2412, is stored in the memory of the embedded device 2402 and is executed using the CPU of the embedded device 2402. In other embodiments, the server(s) 2410 and 2412 of the system are implemented using stand alone hardware of the embedded device 2402, while other necessary files, such as the mapping files 2416 and web documents 2420 are stored in memory of the embedded device 2402, or stored in stand alone memory. In some embodiments, the web documents 2420 are generated dynamically and only stored in the RAM of the embedded device 2402 for transmission to a client device. The system, in some embodiments, comprises management functions and settings other than those previously described. In some embodiments, these additional management functions are integrated into the system architecture. For example, as depicted, the system comprises configuration functions 2422 to configure the system, security functions 2424, such as settings to restrict who may utilize the system, encryption settings, MAC address settings, etc., and also comprises other customizable application functions 2426. For example, the customized application function 2426 permits a user to create a “one button” configuration of one or more embedded device(s) 2402. The user, in some embodiments, will specify an icon on the graphical user interface of the system to perform multiple underlying functions. When clicked, the icon's abstraction invokes many different HTML client calls to other embedded device Web GUIs to accomplish the desired configuration function.

Operation of the system depicted in FIG. 24, according to some embodiments, is now discussed. A web browser 2404 of a client device, in some embodiments, makes XML API calls 2406 and/or Java Applet calls 2408 to a web server 2410 or Java server 2412 of the system. Using a system mapping engine 2414 that is in turn configured using mapping files 2416, the system generates new requests based on the incoming requests and transmits those new requests to the legacy web server 2418 of the embedded device 2402 for execution using the legacy user interface of the embedded device 2402. After execution using the legacy user interface, the web server 2418 transmits responses to the mapping engine 2414, which maps the responses using the mapping files 2416 into customized responses for the client device. The customized responses, in some embodiments, are dynamically generated web documents 2420. The customized responses are then transmitted to the client device using the web server 2410 or the Java server 2412.

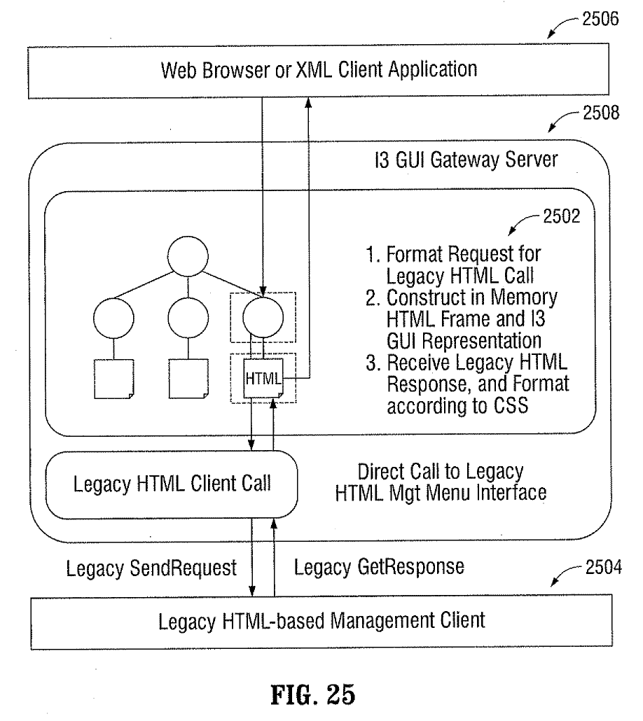

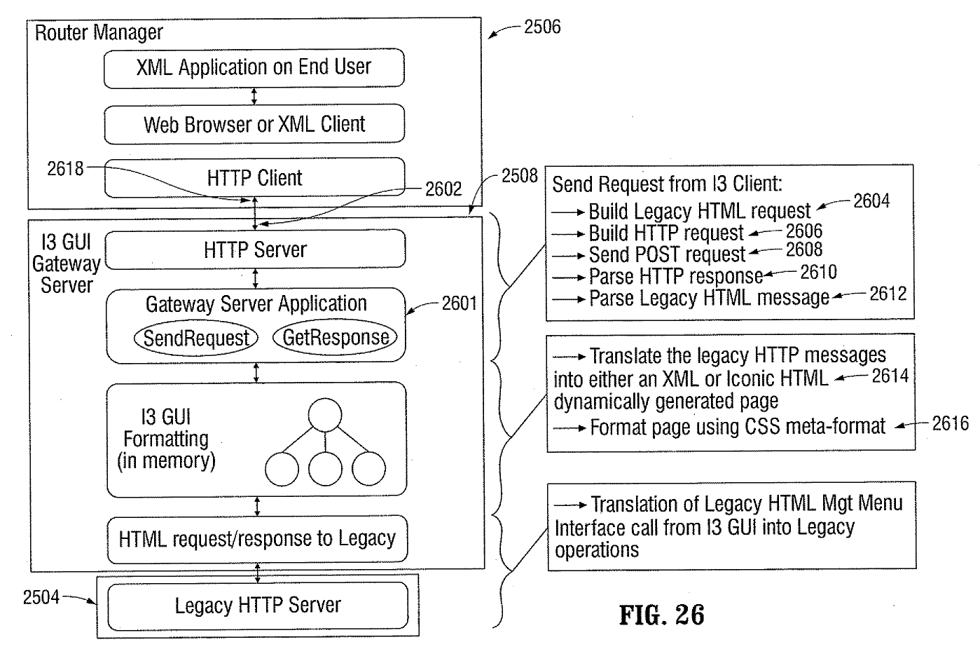

Referring now to FIGS. 25 and 26, depicted are mapping processes for the system, according to various embodiments. In some embodiments, the mapping engine 2502 of the system uses mapping files to generate a legacy HTML call for an embedded device 2504 based on the incoming user request received by the system server(s) 2508 from the client device 2506. The server(s) 2508 then transmits the generated legacy HTML call to the embedded device 2504. Since the system, in some embodiments, is running on the embedded device 2504, the mapping engine 2502 of the system constructs in the memory of the embedded device 2504 an HTML frame and the graphical user interface for the user of the embedded device 2504. When a response is received from the embedded device's 2504 legacy interface, that response is again formatted by the mapping engine 2502 using CSS and/or other files and included as a part of the graphical user interface, which is then transmitted to the client device 2506 in response to the incoming user request. This response may be in the form of an HTML page, or may be XML or Java based responses. Referring specifically to FIG. 26, the gateway server application 2601 controls the input and output responses of the server(s) 2508

In some embodiments, the system defines a standard method to transfer legacy messages and requests over HTTP. In some embodiments, the system utilizes the following API for its legacy HTML management interface:

```
SendRequest
  <m:SendRequest I3-GUI:m=”http://legacy.com”>
  <m:community>public</ m:community><m:version>1</m:version>
  <m:path>// iPConfig</m:path></m:SendRequest>
getResponse
  <m:getResponse I3-GUI:m=”http://legacy.com”>
  <rpc:result I3-GUI:rpc=”http:// http://legacy.com/xml”>
  <ifSpeed>64000</iPConfig></rpc:result></m:getResponse>
```

Described now is the operation flow of the mapping process, according to some embodiments. After receiving a request 2602 from a client device 2506, the mapping engine builds a legacy HTML request 2604, builds an HTTP request 2606, and transmits a POST request 2608 to the web server of the embedded device 2504. As a result, the management functions of the client device 2506 have been translated from the graphical user interface call to a call appropriate for the legacy interface of the embedded device 2504. After receiving a response from the embedded device 2504, the system parses the HTTP response 2610, parses the legacy HTML message 2612 contained in the response, translates the parsed HTTP message 2614 using the appropriate mappings, and formats the translated messages 2616 for transmission 2618 back to the client device 2506.

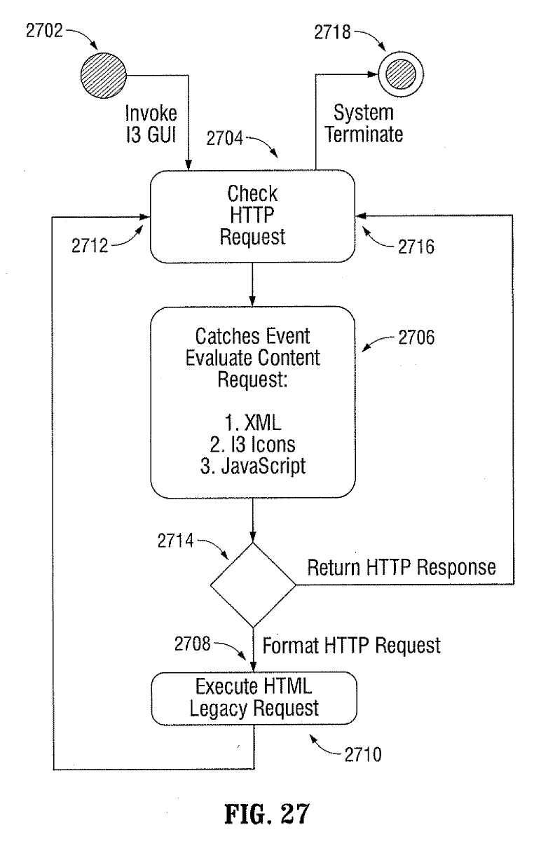

Referring now to FIG. 27, depicted is an event, condition, action flow diagram of a system according to an embodiment. In some embodiments, an incoming user request 2702 is checked 2704 so that the system can determine an appropriate response. In some embodiments, legacy HTML is encapsulated in the system over HTTP. In some embodiments, the content of the request, such as its parameter values, is checked 2706 to ensure it is valid, and the system will not proceed if the user transmits an illegal or harmful operation request. Based on these initial events and conditions, the system issues HTTP requests 2708 to the embedded device, which then executes the requests 2710. Responses from the embedded device 2712 are then collected and checked at 2704 and 2706 and then formatted 2714 for return to the user 2716, 2718.

The system and its graphical user interface can be implemented using technologies other than those described. For instance, in one embodiment, the graphical user interface is implemented as an Adobe Flash object. In some embodiments, where the graphical user interface is implemented using Flash, the graphical user interface is embedded in an HTML page and executed by a Flash compatible plug-in for the browser application. The Flash object stores data files and/or communicates with the hardware (or software/firmware controlling the hardware) of the embedded device to properly configure the device. For instance, in some embodiments, the systems and/or the graphical user interface uses Flash SOL files to maintain the configuration of the embedded device. In other embodiments, technologies such as Java, Java Applets, Synchronized Multimedia Integration Language (SMIL), or Microsoft Silverlight are used to implement the graphical user interface. Such technologies also permit the system and the graphical user interface to configure the device and to operate in conjunction with a standard web browser application. In other embodiments, the graphical user interface is executed by a standalone player external from the browser application or other specialized program used to access the telecommunications device.

A further embodiment is computer readable code or program instructions on one or more computer readable mediums capable of carrying out processes discussed above. A computer readable medium is any data storage device that is capable of storing data, or capable of permitting stored data to be read by a computer system. Examples include hard disk drives (HDDs), flash memory cards, such as CF cards, SD cards, MS cards, and XD cards, network attached storage (NAS), read-only memory (ROM), random-access memory (RAM), CD-ROMs, CD-Rs, CD-RWs, DVDs, DVD-Rs, DVD-RWs, holographic storage mediums, magnetic tapes and other optical and non-optical data storage devices. The computer readable medium can also be in distributed fashion over multiple computer systems or devices which are coupled or otherwise networked together and capable of presenting a single view to a user of the medium.

Yet another embodiment is a computer system or similar device configured to access computer readable code or program instructions from a computer readable medium and to execute program instructions using one or more CPUs to carry out embodiments of the invention as described. Such computer system can be, but is not limited to, a typical personal computer, microcomputers, a handheld device such as a cell phone, PDA, BlackBerry, a network router, a telecommunications device, or a more advanced system such as a computer cluster, distributed computer system, server accessed over wired or wireless devices, a mainframe, or a supercomputer. In some embodiments, upon general completion of processes as discussed above, the computer system's computer readable medium comprises a sequence of information objects where each information object represents a device setting, and the entire sequence of information objects represents an abstraction for a given icon. In other embodiments of the invention, during a step of a process discussed above, content in the data structure is stored in the computer readable medium. In another embodiment, content removed from the data structure is deleted from the computer readable medium. In another embodiment, the server(s) of the system are also stored in and accessed from the computer readable medium. In other embodiments, they are implemented using hardware.

In some embodiments, the sequence of information objects is transmitted via a data-transmission network, such as an Ethernet, Bluetooth or infra-red network to a second computer system. In other embodiments, some or all of the content stored in the computer readable medium is transmitted via a similar network. In other embodiments, an icon corresponding to the sequence of information objects is transmitted via the network to a second computer system.

In other embodiments, the computer system generates signals or instructions based on the results of the program instructions and/or the contents of the computer readable medium. For instance, according to some embodiments, the computer system reads the sequence of information objects and uses the sequence to generate signals or instructions to control a telecommunication device. In some embodiments, a representation of an icon is perceptible by a user of the computer system. For example, the computer system can display the icons and the home page, thereby permitting a user of the computer system to select an icon and perform a desired abstraction. For example, a computer system according to one an embodiment of the invention generates one or more images on an LCD, a bead's-up display, or a computer monitor, and permits a user to use a mouse to select a displayed icon to perform the icon's abstraction.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein.

1. An embedded device comprising:
an interface that interacts with the device to configure the device;
a server configured to receive requests for execution by the server using the interface and transmit responses to those requests; and
a graphical user interface system configured to:
receive an incoming request pertaining to the device;
generate an outgoing request in response to the received request, wherein the outgoing request is mapped to the interface;
transmit the outgoing request to the server; and
receive from the server a response to the outgoing request generated after execution of the outgoing request by the server using the interface.

2. The embedded device of claim 1, wherein the received response is used by the system to generate and transmit a new response to a user of the embedded device.

3. The embedded device of claim 1, wherein the interface configures the embedded device based on the outgoing request.

4. The embedded device of claim 1, wherein the incoming request is an XML request.

5. The embedded device of claim 1, wherein the incoming request is a Java call.

6. The embedded device of claim 1, wherein a plurality of responses are received in response to the outgoing request.

7. The embedded device of claim 6, wherein the plurality of responses are received from a plurality of embedded devices.

8. The embedded device of claim 1, wherein the system generates a plurality of outgoing requests in response to the received request.

9. The embedded device of claim 8, wherein the plurality of outgoing requests are generated as a result of an abstraction of a complex embedded device configuration into a single one-click icon of a second interface of the system.

10. The embedded device of claim 8, wherein the plurality of outgoing requests are transmitted to a plurality of embedded devices.

11. The embedded device of claim 1, wherein the system is further configured to transmit the received response to a user of the embedded device.

12. The embedded device of claim 11, wherein the received response is included within a frame of a second interface of the system.

13. The embedded device of claim 12, wherein the frame comprises a plurality of received responses.

14. A method for configuring an embedded device comprising an interface that interacts with the embedded device to configure the embedded device and a server configured to receive requests for the interface and transmit responses to the requests after execution of the requests by the server using the interface, the method comprising;
receiving at a graphical user interface system, via a data-transmission network, an incoming request pertaining to the embedded device;
storing the incoming request in a computer-readable medium of the embedded device;
generating at the graphical user interface system an outgoing request in response to the received request, wherein the outgoing request is mapped to the interface;
transmitting the outgoing request from the system to the server; and
receiving at the graphical user interface system, from the server, a response to the outgoing request after execution of the outgoing request by the server using interface.

15. The method of claim 14, further comprising using the received response to generate and transmit a new response to a user of the embedded device.

16. The method of claim 14, further comprising configuring the embedded device based on the outgoing request.

17. The method of claim 14, wherein the incoming request is an XML request.

18. The method of claim 14, wherein the incoming request is a Java call.

19. The method of claim 14, further comprising receiving a plurality of responses in response to the outgoing request.

20. The method of claim 19, wherein the plurality of responses are received from a plurality of embedded devices.

21. The method of clam 14, further comprising generating a plurality of outgoing requests in response to the received request,

22. The method of claim 21, wherein the plurality of outgoing requests are generated as a result of an abstraction of a complex embedded device configuration into a single one-click icon of a second interface of the system.

23. The method of claim 21, wherein the plurality of outgoing requests are transmitted to a plurality of embedded devices.

24. The method of claim 14, further comprising transmitting the received response from the system to a user of the embedded device.

25. The method of claim 24, further comprising including the received response within a frame of a second interface of the system.

26. The method of claim 25, wherein the frame comprises a plurality of received responses.

27. An embedded device comprising:
a first system server configured to:
receive an incoming request from a client of the embedded device;
generate an outgoing request in response to the incoming request, wherein the outgoing request is mapped to an interface of the embedded device;
transmit the outgoing request to the interface;
receive a generated response;
map the generated response to a response expected by the client; and
transmit the mapped response to the client; and
a second system server comprising the interface and configured to:
receive the outgoing request from the first system server;
execute the outgoing request using the interface to configure the embedded device and generate the response to the outgoing request; and
transmit the generated response to the first system server.
